(19) United States
(12) Patent Application Publication
(10) Pub. No.: US 2011/0262183 A1
(43) Pub. Date: Oct. 27, 2011

(54) IMAGE DEVICE AND IMAGE FORMING APPARATUS

(75) Inventors: Masanori Seto, Kanagawa (JP); Atsuna Saiki, Kanagawa (JP)

(73) Assignee: FUJI XEROX CO., LTD., Tokyo (JP)

(21) Appl. No.: 12/944,406

(22) Filed: Nov. 11, 2010

(30) Foreign Application Priority Data
Apr. 23, 2010 (JP) 2010-099675

(51) Int. Cl. G03G 15/00

(52) U.S. Cl. 399/117; 399/167

(57) ABSTRACT

An imaging device includes a photoconductor, a charging device that charges a photosensitive surface of the photoconductor by a charging member, an optical writing device that forms an electrostatic latent image by irradiating the charged photosensitive surface with light emitted from a light emitting portion, a developing device that develops the image by a developing member, and a support member that rotatably supports the photoconductor and supports the optical writing device at a distance from the photosensitive surface. The charging member and the developing member are provided closer to the optical writing device than a line extending orthogonally to an emitting direction of the light and passing through a center point of a shaft of the photoconductor. An application direction of a pressure to be applied to each of the charging member and the developing member intersects the emitting direction of the light at an acute angle.

### CROSS-REFERENCE TO RELATED APPLICATIONS

This application is based on and claims priority under 35 USC 119 from Japanese Patent Application No. 2010-099675 filed Apr. 23, 2010.

### BACKGROUND

(i) Technical Field

The present invention relates to an imaging device and an image forming apparatus.

(ii) Related Art

In some recent image forming apparatuses using electrophotography, an optical writing device forms an electrostatic latent image on a surface of a photoconductor by irradiating the surface with light based on image information. In the optical writing device, plural light emitting elements, such as light emitting diodes (LEDs), are arranged in line in a direction (main scanning direction) substantially extending in the axial direction of the photoconductor. Light is emitted from the light emitting elements onto the surface of the photoconductor via an optical element such as a convergent lens so as to write a latent image.

### SUMMARY

According to an aspect of the invention, there is provided an imaging device including a cylindrical photoconductor having a photosensitive surface, the photoconductor rotating on a shaft, a charging device that charges the photosensitive surface of the photoconductor by a charging member pressed into contact with the photosensitive surface, an optical writing device that forms an electrostatic latent image by irradiating the charged photosensitive surface of the photoconductor with light emitted from a light emitting portion including a plurality of light emitting elements arranged in an axial direction of the photoconductor, a developing device that develops the electrostatic latent image by a developing member in contact with the photosensitive surface of the photoconductor or a developing member opposing the photosensitive surface of the photoconductor with a gap holding member being disposed therebetween, the gap holding member being in contact with the photosensitive surface, and a support member that rotatably supports the photoconductor while holding the shaft and supports the optical writing device at a distance from the photosensitive surface of the photoconductor, the distance corresponding to a focal length of the light emitted from the light emitting portion. The charging member of the charging device and the developing member of the developing device are respectively provided at portions of the photosensitive surface of the photoconductor closer to the optical writing device than a line extending orthogonally to an emitting direction of the light emitted from the light emitting portion of the optical writing device and passing through a center point of the shaft of the photoconductor, the portions being provided on opposite sides of the optical writing device. Each of an application direction of a pressure to be applied to the charging member and an application direction of a pressure to be applied to the developing member is set to intersect the emitting direction of the light emitted from the light emitting portion at an acute angle.

### BRIEF DESCRIPTION OF THE DRAWINGS

An exemplary embodiment of the present invention will be described in detail based on the following figures, wherein:

FIG. 1 is a schematic cross-sectional view illustrating an outer appearance of an image forming apparatus according to an exemplary embodiment of the present invention;

FIG. 2 is a schematic side view illustrating an outer appearance of an imaging device in the image forming apparatus of FIG. 1;

FIG. 3 is a schematic cross-sectional view of the imaging device of FIG. 2;

FIG. 4 is a partial cross-sectional view conceptually illustrating a mounting structure for a photoconductor drum and an optical writing device;

FIG. 5 explains arrangement conditions of a charging device and a developing device in the imaging device;

FIG. 6 is a partial cross-sectional view conceptually illustrating a mounting structure and state of the photoconductor drum and a charging roller of the charging device;

FIG. 7 is a partial cross-sectional view conceptually illustrating a mounting structure and state of the photoconductor drum and a developing roller of the developing device;

FIG. 8 is a partial cross-sectional view conceptually illustrating a mounting state of the photoconductor drum and the optical writing device that satisfies the arrangement conditions of FIG. 5; and

FIG. 9 illustrates arrangement conditions of the charging device, the developing device, a cleaning device, and a transmitted gear in the imaging device.

### DETAILED DESCRIPTION

An embodiment for carrying out the present invention (hereinafter simply referred to as an exemplary embodiment) will be described below with reference to the attached drawings.

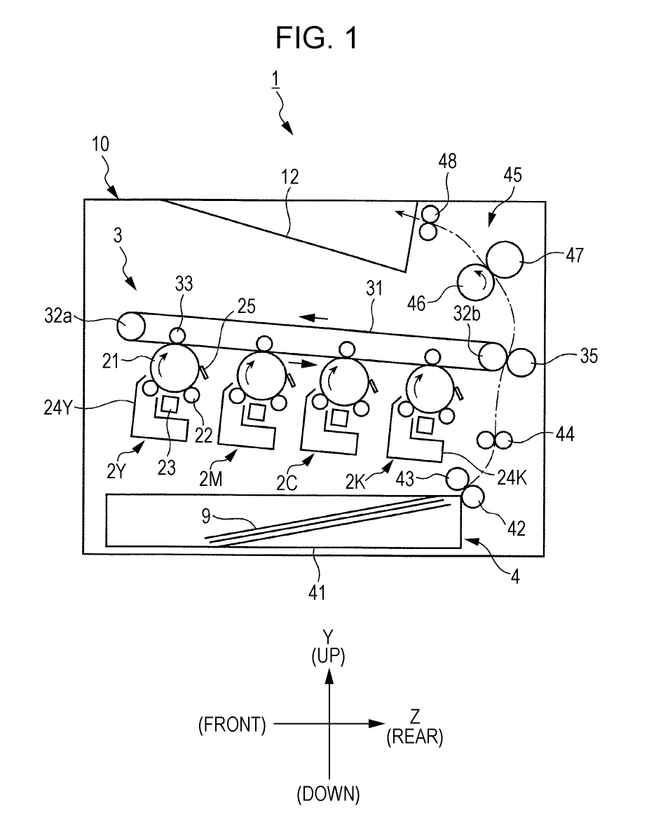

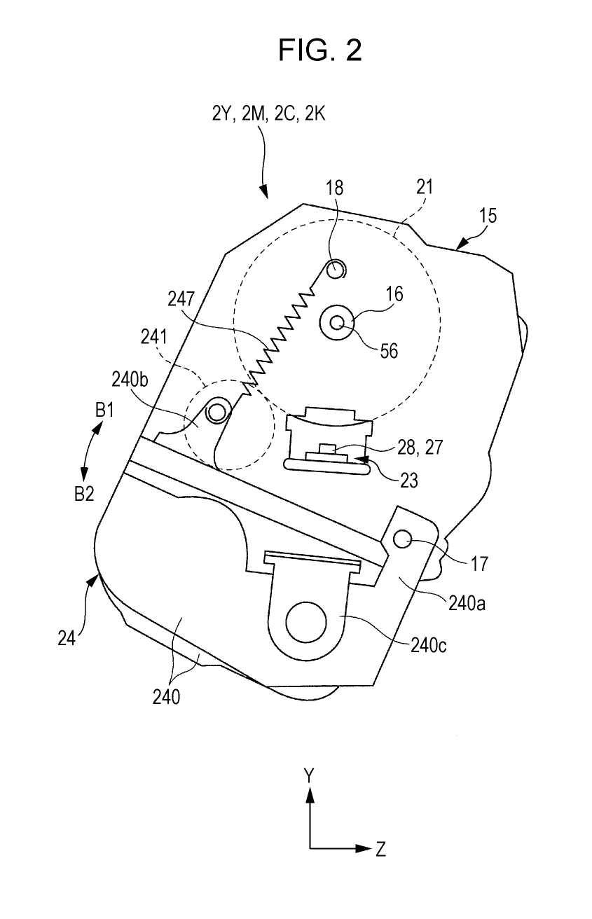

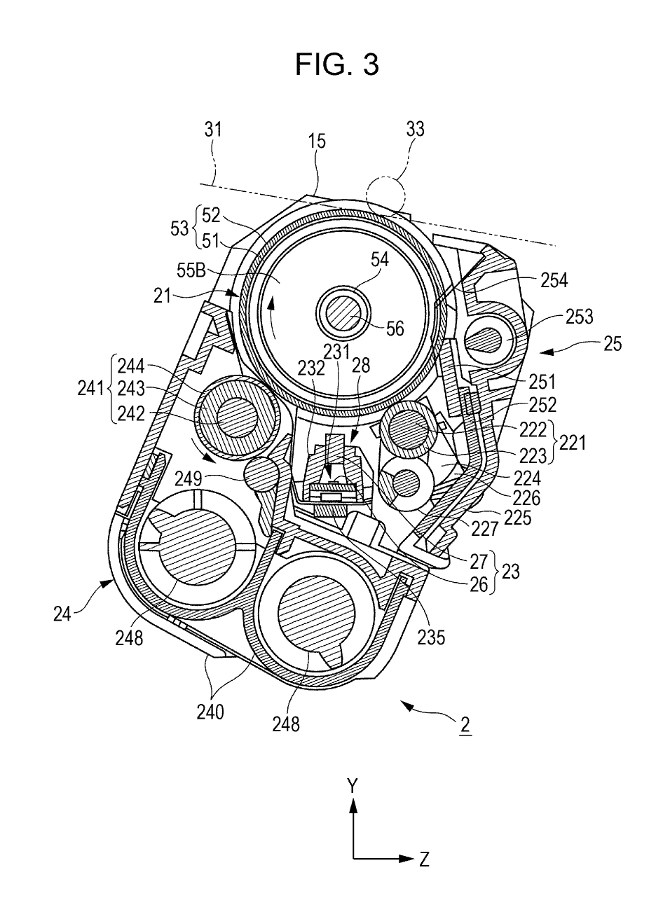

FIGS. 1 to 3 illustrate an image forming apparatus 1 and an imaging device 2 according to an exemplary embodiment. FIG. 1 is a schematic cross-sectional view of the principal part of the image forming apparatus 1, FIG. 2 is a side view illustrating an outer appearance of the imaging device 2, and FIG. 3 is a cross-sectional view illustrating the interior of the imaging device 2. In the figures, arrows X, Y, and Z represent the coordinate axes. A direction along the coordinate axis X indicates a right-left direction in the image forming apparatus 1 and so on, a direction along the coordinate axis Y indicates an up-down direction, and a direction along the coordinate axis Z indicates a front-rear direction.

The image forming apparatus 1 includes an apparatus body 10 formed by a support material, an exterior material, etc. At the bottom of the apparatus body 10, a sheet supply device 4 is provided to store and supply recording sheets 9 serving as recording media on which images are to be formed. At the top of the apparatus body 10, an output receiving portion 12 is provided such that the recording sheets 9 are output and received therein after image formation. In FIG. 1, a one-dot chain line with an arrow indicates a transport path for the recording sheets 9.

In the sheet supply device 4, the uppermost one of the recording sheets 9 stored in a sheet storing unit 41 is fed out by a supply roller 42, and is then handled by cooperation of the supply roller 42 and a handling roller 43 that is in contact with the supply roller 42. In this way, the recording sheets 9 are fed out one by one. The fed recording sheet 9 is temporarily stopped by transport adjusting rollers 44, and is then transported between an intermediate transfer unit 3 and a secondary transfer device 35 that will be described below (a secondary transfer position) at a required timing (a timing corresponding to a secondary transfer step that will be described below).

In the apparatus body 10, the imaging device 2, the intermediate transfer unit 3, the secondary transfer device 35, and a fixing device 45 are arranged. The imaging device 2 includes four imaging devices 2Y, 2M, 2C, and 2K that form developer (toner) images of four colors of yellow (Y), magenta (M), cyan (C), and black (K), respectively. In the exemplary embodiment, the imaging devices 2Y, 2M, 2C, and 2K are arranged in order of decreasing height (in an inclined state).

Each of the imaging devices 2Y, 2M, 2C, and 2K includes a photoconductor drum 21 (Y, M, C, and K) that rotates in a required direction (direction of arrow), a charging device 22 that charges a surface (photosensitive surface) of a photoconductor drum 21, an optical writing device 23 serving as a latent-image forming device, a developing device 24 (Y, M, C, and K), and a drum cleaning device 25 that removes toner or the like remaining on the photosensitive surface of the photoconductor drum 21 after transfer.

The photoconductor drum 21 is formed by a cylindrical photoconductor that rotates on a shaft 56. The charging device 22 is of a contact charging type including a charging roller 221 that rotates in pressing contact with the photosensitive surface of the photoconductor drum 21. The optical writing device 23 is formed by an LED print head in which plural LEDs 26 are arranged in line in an axial direction A of the photoconductor drum 21. The developing device 24 includes a developing roller 241 that rotates at a required distance S from the photosensitive surface in a manner such that gap holding rollers 243 in pressing contact with the photosensitive surface are provided therebetween. The developing roller 241 transports two-component developer formed by toner and carrier to a developing area. The drum cleaning device 25 includes an elastic blade 251 that is in pressing contact with the photosensitive surface of the photoconductor drum 21. A charging voltage and a developing bias voltage are applied from a power supply (not shown) to the charging roller 221 and the developing roller 241, respectively.

In each imaging device 2 (Y, M, C, and K), image formation is performed as follows. First, the photosensitive surface of the rotating photoconductor drum 21 is charged with a required potential by the charging roller 221 of the charging device 22, and is then irradiated with light based on image information input to the image forming apparatus 1 by the optical writing device 23, whereby an electrostatic latent image of the corresponding color component is formed with the required potential. Subsequently, the electrostatic latent image of the color component on the photoconductor drum 21 is developed with the corresponding color developer supplied from the developing roller 241 of the developing device 24. Through the above steps, toner images of the four colors Y, M, C, and K are formed. The toner images on the photoconductor drums 21 are primarily transferred onto an intermediate transfer belt 31 of the intermediate transfer unit 3, as will be described below. After the toner images are transferred, the photosensitive surfaces of the photoconductor drums 21 are cleaned by the drum cleaning devices 25.

The intermediate transfer unit 3 includes an endless intermediate transfer belt 31 having an outer peripheral surface on which the color toner images formed on the photoconductor drums 21 of the imaging devices 2Y, 2M, 2C, and 2K are to be transferred, plural support rollers 32a and 32b around which the intermediate transfer belt 31 is wound to rotate in contact with the photoconductor drums 21, and primary transfer devices 33 that primarily transfer the toner images on the photoconductor drums 21 onto the outer peripheral surface of the intermediate transfer belt 31. The support roller 32b is a driving roller, and rotates the intermediate transfer belt 31 in the direction of the arrow by rotational force transmitted from a rotating device (not shown). The primary transfer devices 33 are primary transfer rollers that press the outer peripheral surface of the intermediate transfer belt 31 against the photosensitive surfaces of the photoconductor drums 21 by contact with an inner peripheral surface of the intermediate transfer belt 31. A primary transfer bias voltage is applied to the primary transfer rollers 33.

In the intermediate transfer unit 3, toner images are electrostatically and primarily transferred from the photoconductor drums 21 of the imaging devices 2Y, 2M, 2C, and 2K onto the outer peripheral surface of the intermediate transfer belt 31 rotating in the direction of the arrow by the action of the primary transfer rollers 33. By virtue of this primary transfer, a multicolor toner image obtained by superimposing plural color toner images or a toner image of one color (black in the exemplary embodiment) is held on the outer peripheral surface of the intermediate transfer belt 31.

The secondary transfer device 35 secondarily transfers the toner image primarily transferred on the outer peripheral surface of the intermediate transfer belt 31 onto a recording sheet 9. The secondary transfer device 35 is formed by a secondary transfer roller that is driven by contact with a portion of the outer peripheral surface of the intermediate transfer belt 31 wound around the support roller 32b. A secondary transfer bias voltage is applied to the secondary transfer roller 35. In the secondary transfer device 35, an unfixed toner image held on the intermediate transfer belt 31 is electrostatically and secondarily transferred onto a recording sheet 9 transported between the intermediate transfer belt 31 and the secondary transfer roller 35.

The fixing device 45 fixes the secondarily transferred unfixed toner image on the recording sheet 9, and is located above the secondary transfer device 35. The fixing device 45 includes a roller-shaped or belt-shaped heating rotating body 46 having a fixing surface to be heated to a required temperature by a heating unit, and a roller-shaped or belt-shaped pressurizing rotating body 47 that contacts the fixing surface of the heating rotating body 46 with a required pressure so as to form a fixing portion through which the recording sheet 9 (fixing object) holding the unfixed toner image passes. In the fixing device 45, the recording sheet 9 on which the unfixed toner image is transferred is led into the fixing portion between the heating rotating body 46 and the pressurizing rotating body 47, where the unfixed toner image is melt and fixed on the recording sheet 9 by the application of heat and pressure.

After fixing, the recording sheet 9 is discharged from the fixing device 45, and is output into the output receiving portion 12 by output rollers 48. Thus, a monochromatic or multicolor image is formed by developer on one side of the recording sheet 9.

Next, the imaging devices 2Y, 2M, 2C, and 2K will be described.

First, as illustrated in FIGS. 2 to 4, each of the four imaging devices 2Y, 2M, 2C, and 2K is formed as an integral structure in which the charging device 22, the optical writing device 23, the developing device 24, and the drum cleaning device 25 are attached to a support plate 15 for rotatably supporting the photoconductor drum 21.

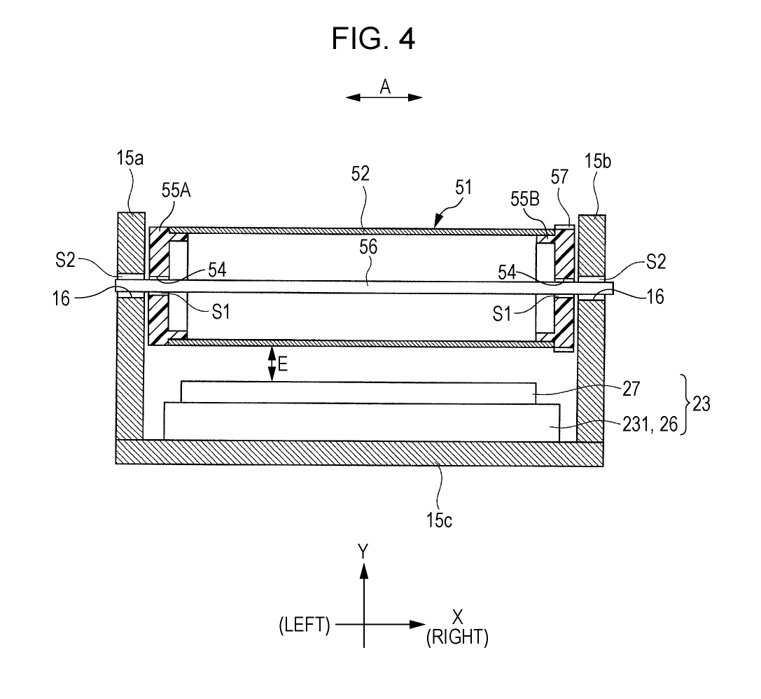

As illustrated in FIGS. 3 and 4, the photoconductor drum 21 includes a drum body portion 53 having a cylindrical base 51 and a photosensitive layer 52 provided on an outer peripheral surface of the base 51, end holding plates (flanges) 55A and 55B shaped like two-stage discs, fixedly fitted in apertures at both ends of the base 51 and having shaft receiving holes 54, and a shaft 56 extending through the shaft receiving holes 54 of the end holding plates 55A and 55B so as to rotatably hold the drum body portion 53. The photosensitive layer 52 is a photoinduced layer formed of, for example, an organic photosensitive material, and includes a surface protective layer and so on. A surface portion of the base 51 where the photosensitive layer 52 is provided serves as a photosensitive surface. An outer peripheral portion of a large-diameter portion of the end holding plate 55B, of the two end holding plates 55, is formed as a transmitted gear 57 to be meshed with a driving transmission gear of a driving transmission device (not shown) In other words, the end holding plate 55B is formed as a geared end holding plate.

The photoconductor drum 21 is supported with the shaft 56 being fixed to shaft support holes 16 that are provided in the support plate 15 of the imaging device 20 so as to serve a positioning function. The end holding plates 55 are formed of a synthetic resin having a high slidability with respect to the shaft 56. The photoconductor drum 21 is supported rotatably on the shaft 56 extending through the shaft receiving holes 54 provided in the end holding plates 55.

As illustrated in FIG. 4, the support plate 15 includes a pair of left and right side plates 15a and 15b spaced at a required interval, and a connecting portion 15c that connects the side plates 15a and 15b. The shaft support holes 16 provided in the side plates 15a and 15b are positioned such that the shaft 56 supported by the shaft support holes 16 is kept parallel to a light emitting portion 231 of the optical writing device 23 that will be described below.

The optical writing device 23 includes a light emitting portion 231 in which plural LEDs 26 arranged in line in the axial direction A of the photoconductor drum 21 are mounted, and a light emitting portion 28 having a Selfoc lens 27 for converging light emitted from the LEDs 26 of the light emitting portion 231 and a holding portion (housing) 232 for maintaining the distance between the LEDs 26 of the light emitting portion 231 and the Selfoc lens 27. The optical writing device 23 is mounted with the holding portion 232 being fixed to the connecting portion 15c of the support plate 15 in a manner such that the Selfoc lens 27 of the light emitting portion 28 opposes the photosensitive surface (image forming area) of the photoconductor drum 21. Also, a control board 235 for controlling light emission from the LEDs 26 of the light emitting portion 231 is attached to the center of the holding portion 232 in the axial direction A. On the basis of an image signal transmitted from an image processing unit (not shown) via a connecting line, the corresponding LED 26 in the light emitting portion 231 is driven to blink.

The optical writing device 23 is attached to the connecting portion 15c at a distance E from the photosensitive surface of the photoconductor drum 21. The distance E corresponds to the focal length of light emitted from the light emitting portion 28. This allows the distance E between the optical writing device 23 and the photoconductor drum 21 to be easily maintained by the support plate 15.

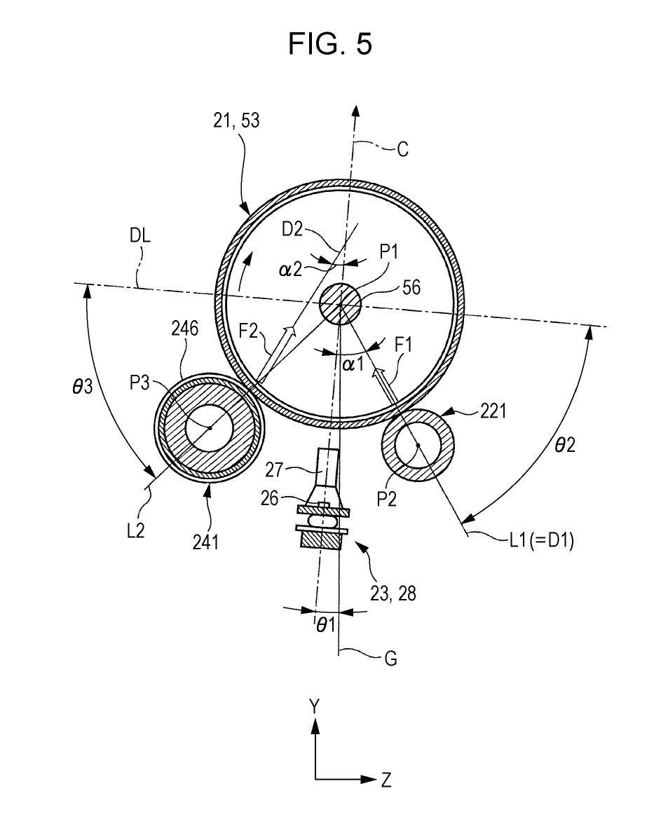

As illustrated in FIGS. 3 and 5, in the charging roller 221 of the charging device 22, an elastic layer 223 adjusted to a required resistance is provided on a shaft 222. Further, as illustrated in FIGS. 3 and 5, a bearing 224 for rotatably holding the shaft 222 is attached to the connecting portion 15c of the support plate 15 with a pressurizing mechanism 226 being disposed therebetween. The pressurizing mechanism 226 is formed by a pressurizing spring 225 that presses the charging roller 221 toward the photoconductor drum 21.

With this structure, the elastic layer 223 of the charging roller 221 is pressed into contact with the photosensitive surface (a portion extending in the axial direction A) of the photoconductor drum 21 with a required pressure. A cleaning roller 227 illustrated in FIG. 3 cleans the surface of the charging roller 221 by contact therewith.

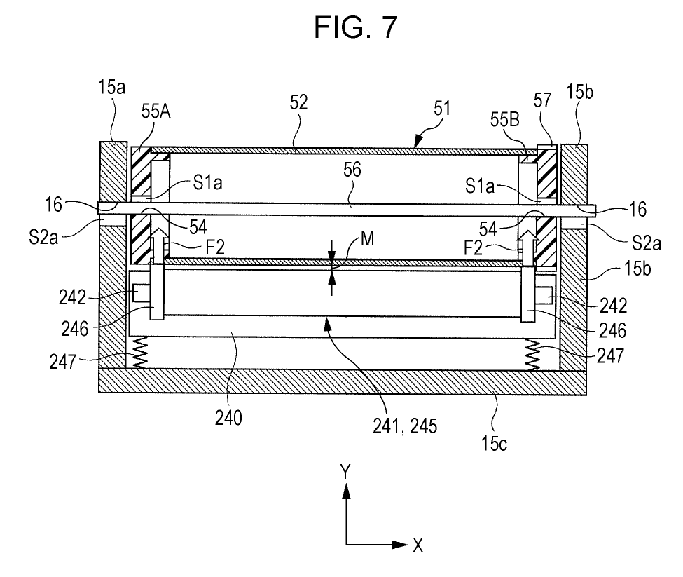

As illustrated in FIGS. 2 and 3, the developing device 24 includes a storage unit that stores the developer and a housing 240 having a developing aperture opening toward the photoconductor drum 21. The developing roller 241 is rotatably held such that only a part of the developing roller 241 is exposed from the developing aperture of the housing 240. In the developing roller 241, a roll-shaped magnet portion 243 is provided on a shaft 242, and a cylindrical sleeve 245 that rotates in a direction of the arrow is provided around the magnet portion 243. Also, as illustrated in FIGS. 5 and 7, gap holding rollers 246 that rotate in contact with the photosensitive surface (outside an image forming area) of the photoconductor drum 21 are provided at either end of the shaft 242. The gap holding rollers 246 serve to hold the developing roller 241 (the sleeve 245 in actuality) with a gap M from the photosensitive surface of the photoconductor drum 21. The gap holding rollers 246 are shaped like discs having a radius larger than the radius of the sleeve 245 by an amount equal to the distance S.

As illustrated in FIG. 2, a first mounting portion 240a projects upward on a developer storage unit side of the housing 240 of the developing device 24. The first mounting portion 240a is attached such as to rock in directions of arrows B1 and B2 on a shaft 17 provided on a lower outer side of the side plate 15b of the support plate 15. Also, a second mounting portion 240b projects upward on a developing roller 241 side of the housing 240. The second mounting portion 240b is attached such as to be pulled toward the support plate 15 by an extension spring 247. The extension spring 247 is caught at one end by the second mounting portion 240b, and is caught at the other end by a spring mounting portion 18 provided on an upper outer side (above the shaft support holes 16) of the side plate 15b of the support plate 15.

With this structure, the housing 240 of the developing device 24 is kept rocked on the shaft 17 in the direction of arrow B1 by receiving the pulling force of the extension spring 247. Hence, the developing roller 241 is pressed against the photosensitive surface of the photoconductor drum 21 with a required pressure with the gap holding rollers 246 being disposed therebetween, and opposes the photosensitive surface of the photoconductor drum 21 with the gap M therebetween. In FIG. 3, an agitation and transport member (rotating screw) 248 agitates and transports the developer from the storage unit of the housing 240, and a layer-thickness regulating roller (trimmer) 249 regulates the layer of the developer held on the developing roller 241 to a required thickness (layer). In FIG. 2, a supply developer receiving portion 240c receives supply developer transported from a developer supply device (not shown). In FIG. 7, the extension spring 247 is replaced with a pressurizing spring.

As illustrated in FIG. 3, the elastic blade 251 of the drum cleaning device 25 is rectangular, and extends long in the axial direction A of the photoconductor drum 21. The elastic blade 251 is attached to an upper end of an attachment plate 252 that is fixed at a lower end to the connecting portion 15c of the support plate 15. Also, the elastic blade 251 protrudes from the upper end of the attachment plate 252 by a required length, and an upper end of the elastic blade 251 is set to cut in the photosensitive surface of the photoconductor drum 21 by a required amount. In FIG. 3, for convenience, a lower corner portion of the upper end of the elastic blade 251 cuts in the photosensitive surface of the photoconductor drum 21. Further, the elastic blade 251 is set such that the upper end thereof contacts the photoconductor drum 21 against the rotating direction of the arrow of the photoconductor drum 21.

With this structure, the elastic blade 251 is pressed against the photosensitive surface of the photoconductor drum 21 with the required pressure. In FIG. 3, a rotating transport member 253 recovers attached materials, such as toner, scraped off by the elastic blade 251 and transports the adhesive materials to a recovery unit (not shown). A film-shaped sealing member 254 prevents attached materials, such as toner, from floating and leaking outside.

As illustrated in FIG. 4, in the imaging device 2, the optical writing device 23 is fixed to the support plate 15 that rotatably supports the photoconductor drum 21. Hence, the distance E between the optical writing device 23 and the photoconductor drum 21 is kept at a distance corresponding to the focal length of light in the light emitting portion 28 of the optical writing device 23.

Strictly, however, if there are unnecessary gaps S in the mounting portions in contact with the shaft 56 of the photoconductor drum 21, the distance E may change. The mounting portions in contact with the shaft 56 include the shaft receiving holes 54 of the end holding plates 55A and 55B and the shaft support holes 16 of the support plate 15, as illustrated in FIG. 4. It is conceivable that the unnecessary gaps S (S1, S2) in the shaft receiving holes 54 and the shaft support holes 16 are caused, for example, during the production process of the imaging device 2 or because of the later use frequency. For example, the gaps S1 and S2 are about 10 to 100 μm. If these unnecessary gap S exists, the photoconductor drum 21 is sometimes displaced (from the support plate 15) via the shaft 56 by the gap S. As a result, the photoconductor drum 21 is displaced relative to the optical writing device 23 that is fixed to the support plate 15 (that does not move). Hence, the distance E between the optical writing device 23 and the photoconductor drum 21 may change.

In the exemplary embodiment, the charging roller 221 of the charging device 22 and the developing roller 241 of the developing device 24 that are particularly predicted to easily affect the position change of the photoconductor drum 21, of the components arranged in contact with the photoconductor drum 21 (the charging roller 221, the developing roller 241, the elastic blade 251, the primary transfer rollers 33, and the transmitted gear 57), are arranged (set) so as to satisfy the following conditions.

That is, as illustrated in FIG. 5, the charging roller 221 of the charging device 22 and the developing roller 241 of the developing device 24 are in contact with portions of the photosensitive surface of the photoconductor drum 21 closer to the optical writing device 23 than a line DL extending orthogonally to a light emitting direction of the light emitted from the light emitting portion 28 of the optical writing device 23 and passing through the center point P1 of the shaft 56 of the photoconductor drum 21. The contact portions are on the opposite sides of the optical writing device 23. Here, the words “extending orthogonally” refer to intersecting at an intersection angle within the range of 90°±5°. The elastic blade 251, the primary transfer rollers 33, and the transmitted gear 57 are excluded from the components in contact with the photoconductor drum 21, because they are less influential in displacement of the photoconductor drum 21 than the charging roller 221 and the developing roller 241.

More specifically, for example, the optical writing device 23 is set such that an angle θ1 formed between the light emitting direction C and a gravitational direction G (along the coordinate axis Y) is 4°. Further, the charging roller 221 is set in contact with a surface portion of the photoconductor drum 21 such that an angle θ2 at a position closer to the optical writing device 23 than the line DL orthogonal to the light emitting direction C of the optical writing device 23 (an angle formed between a line L1 passing through the center point P1 of the shaft 56 of the photoconductor drum 21 and the line DL) is 57°. In addition, the developing roller 241 is set in contact with a surface portion of the photoconductor drum 21 such that an angle θ3 at a position closer to the optical writing device 23 than the line DL (an angle formed between a line L3 passing through the center point P1 of the shaft 56 of the photoconductor drum 21 and a rotation center point P3 of the developing roller 241) is 49°. In this case, for example, the photoconductor drum 21 has a roller diameter of 30 mm, the charging roller 221 has a roller diameter of 9 mm, and the developing roller 241 has a roller diameter (sleeve diameter) of about 12 mm. The gap M between the developing roller 241 and the photoconductor drum 21 is set to be about 0.4 mm.

In addition, as illustrated in FIG. 5, the charging roller 221 and the developing roller 241 are set such that an application direction D1 of a pressure F1 to be applied to the charging roller 221 and an application direction D2 of a pressure F2 to be applied to the developing roller 241 intersect the light emitting direction C of light from the light emitting portion 28 of the optical writing device 23 at acute angles α (α1, α2), respectively.

The pressure F1 is applied to the charging roller 221 by spring force of the pressurizing spring 225. The application direction D1 of this pressure F1 coincides with the line L1 passing through the center point P1 of the shaft 56 of the photoconductor drum 21 and the rotation center point P2 of the charging roller 221. Further, the pressure F1 is the sum of spring forces of two pressurizing springs 225. In contrast, the pressure F2 is applied to the developing roller 241 by spring force of the extension spring 247. The application direction D2 of this pressure F2 coincides with a line connecting the contact portion of the developing roller 241 (gap holding rollers 246) with the photosensitive surface of the photoconductor drum 21 and a center point of the spring mounting portion 18 of the support plate 15. The pressure F2 is the sum of spring forces of two extension springs 247. In this case, the intersecting angle α1 between the application direction D1 of the pressure F1 and the light emitting direction C is about 33°, and the intersecting angle α2 between the application direction D2 of the pressure F2 and the light emitting direction C is about 20°.

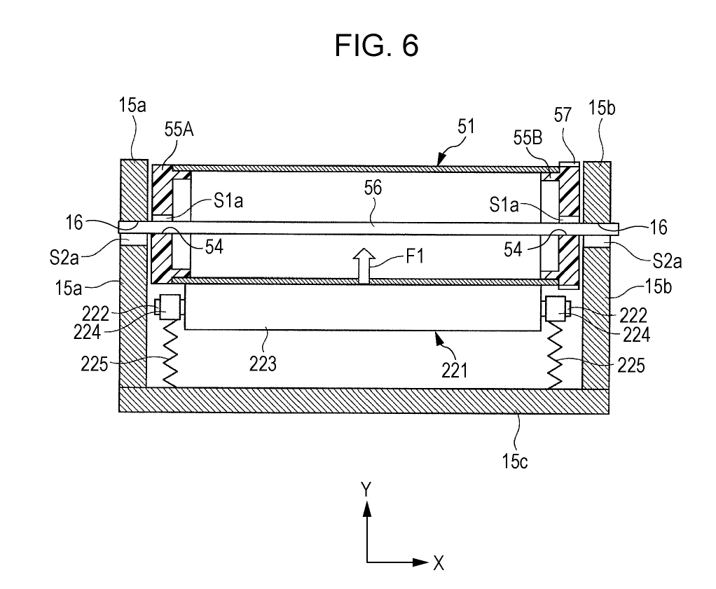

In the imaging device 2, since the charging roller 221 of the charging device 22 and the developing roller 241 of the developing device 24 are arranged so as to satisfy the above-described conditions, the photoconductor drum 21 is kept pressed by at least the charging roller 221 and the developing roller 241, and is displaced apart from the optical writing device 23. With this, as illustrated in FIGS. 6 and 7, the shaft 56 of the photoconductor drum 21 is pressed and displaced by the charging roller 221 and the developing roller 241 in the shaft receiving holes 54 of the end holding plates 55A and 55B and the shaft support holes 16 of the support plate 15. Hence, the unnecessary gap S1 at the shaft receiving holes 54 (FIG. 4) and the unnecessary gap S2 at the shaft support hole 16 (FIG. 4) are removed.

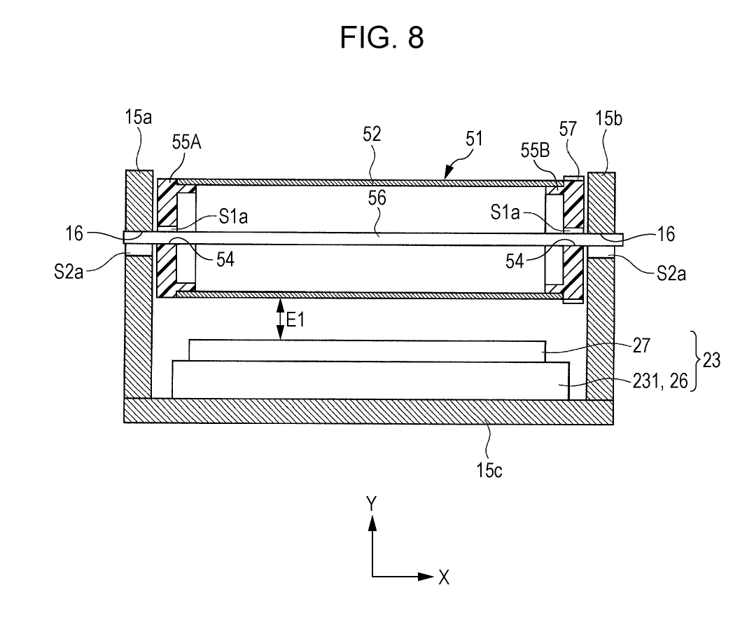

As a result, as illustrated in FIG. 8, the photoconductor drum 21 (drum body portion 53) rotates while being pressed against the shaft 56 fixed at the displaced position. Thus, the distance E between the photosensitive surface of the photoconductor drum 21 and the light emitting portion 28 of the optical writing device 23 (upper surface of the Selfoc lens 27) is stably kept at a distance E1. The distance E1 obtained in this state is set as the above-described distance corresponding to the focal length. In FIGS. 6 to 8, S1a and S2a exaggeratedly indicate the unnecessary gaps S1 and S2 at the shaft receiving holes 54 and the shaft support holes 16 that remain when the shaft 56 is pressed against one side of each hole because of the displacement of the photoconductor drum 21.

Therefore, during image formation, light emitted from the light emitting portion 28 of the optical writing device 23 is stably applied (converged) onto the photosensitive surface of the photoconductor drum 21 with the distance corresponding to the focal length being disposed therebetween, so that an electrostatic latent image is stably formed on the photosensitive surface of the photoconductor drum 21 and an image having a stable quality may be obtained finally. Further, the distance E1 between the optical writing device 23 and the photoconductor drum 21 does not easily change, but is stably maintained even in long-term use of the imaging device 2 and the image forming apparatus 1.

In the exemplary embodiment, arrangement conditions may be set with consideration of the influences of the elastic blade 251 and the transmitted gear 57, which are the components arranged in contact with the photoconductor drum 21, in addition to the charging roller 221 and the developing roller 241.

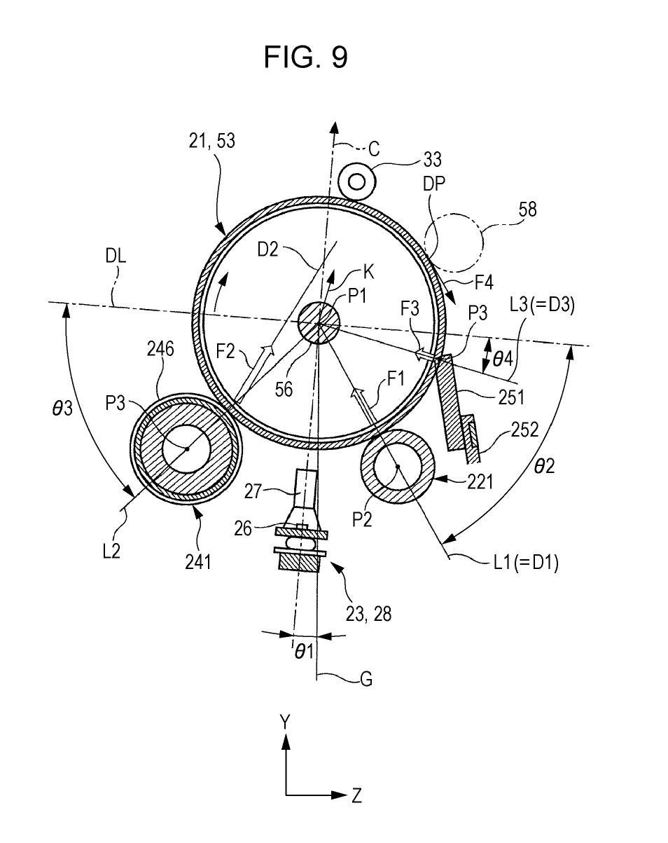

That is, as illustrated in FIG. 9, the pressure F1 to be applied to the charging roller 221, the pressure F2 to be applied to the developing roller 241, a pressure F3 to be applied to the elastic blade 251, and a pressure F4 produced by the rotational force to be transmitted to the transmitted gear 57 are set so that the direction of a resultant force K obtained by combining all of the pressures F1 to F4 coincides with the light emitting direction C of light emitted from the light emitting portion 28 of the optical writing device 23. In FIG. 9, a driving transmission gear 58 transmits a rotational force produced by a rotating device (not shown) provided in the apparatus body 10, and is meshed with the transmitted gear 57 of the photoconductor drum 21.

The resultant force K is a vector (line) obtained by combining the pressures F1 to F4 with consideration of the directions and magnitudes thereof, and the vector starts from the center point P1 of the shaft 56 of the photoconductor drum 21. The pressures F1 to F4 start from the photosensitive surface of the photoconductor drum 21 (points to be meshed with the transmitted gear 57). The pressure F1 is expressed by the direction and magnitude of the spring force applied by the pressurizing spring 225. The pressure F2 is expressed by the direction and magnitude of the spring force applied by the extension spring 247. The pressure F3 is expressed by the direction and amount of cut of the elastic blade 251 in the point on the photosensitive surface of the photoconductor drum 21. The pressure F4 is expressed by the direction and magnitude of the moment force produced at the pressure angle of the driving transmission gear 58. Coincidence of the direction of the resultant force K with the light emitting direction C means a state in which the intersecting angle of lines indicating the directions is within the range of about 0°±30°.

In the exemplary embodiment, for example, the pressures F1 to F4 are set as follows. The pressure F1 is set to have a direction equal to the above-described application direction D1 and a magnitude of 500 gf (≈4.9 N)×2. The pressure F2 is set to have a direction equal to the above-described application direction D2 and a magnitude of 700 gf (≈6.86 N)×2. The pressure F3 is set to have a direction equal to an application direction represented by a line L3 passing through the center point P1 of the shaft 56 of the photoconductor drum 21 and the corner portion P3 of the elastic blade 251 in contact with the photosensitive surface. The pressure F3 is also set to have a magnitude of 100 gf (≈0.98 N)×2. The pressure F4 is set to have a direction represented by the pressure angle (20° of the driving transmission gear 58 and a magnitude of 0.195 Nm. Further, the elastic blade 251 is set in contact with the photosensitive surface at a position such that an angle θ04 formed between the elastic blade 251 and the line DL is 12°. In addition, the driving transmission gear 58 is meshed with the transmitted gear 57 of the photoconductor drum 21 at a position (mesh position) DP substantially intersecting the light emitting direction C.

From the above-described settings, the direction of the resultant force K of the pressures F1 to F4 intersects the light emitting direction C of the light emitting portion 28 of the optical writing device 23 at the intersecting angle ranging from 0° to 30°, that is, substantially extends in the light emitting direction C.

In the imaging device 2, since the direction of the resultant force K of the pressures F1 to F4 is set, as described above, the photoconductor drum 21 is kept pressed by the direction (and magnitude) of the resultant force K, and is reliably displaced apart from the optical writing device 23. With this structure, as illustrated in FIGS. 6 and 7, the shaft 56 of the photoconductor drum 21 is displaced in the direction of the resultant force K at the shaft receiving holes 54 of the end holding plates 55A and 55B and the shaft support holes 16 of the support plate 15. Hence, the unnecessary gaps S1 at the shaft receiving holes 54 (FIG. 4) and the unnecessary gaps S2 at the shaft support holes 16 (FIG. 4) are removed.

As a result, as illustrated in FIG. 8, the photoconductor drum 21 (drum body portion 53) stably rotates while being pressed against the shaft 56 fixed at the displaced position. Further, the distance E between the photosensitive surface of the photoconductor drum 21 and the light emitting portion 28 of the optical writing device 23 is more stably kept at E1.

Therefore, during image formation, light emitted from the light emitting portion 28 of the optical writing device 23 is more stably applied (converged) onto the photosensitive surface of the photoconductor drum 21 through the distance E1 corresponding to the focal length, so that an electrostatic latent image is more stably formed on the photosensitive surface of the photoconductor drum 21 and an image having a more stable quality may be obtained finally. Further, the distance E1 between the optical writing device 23 and the photoconductor drum 21 does not easily change, but is more stably maintained even in long-term use of the imaging device 2 and the image forming apparatus 1.

For example, the pressures F1 to F4 in the completed imaging device 2 may be calculated by measuring the spring constants or may be measured with a commercially available pressure meter. Further, for example, the resultant force K may be checked by measuring the pressures (states of pressure) received from the shaft 56 in the unnecessary gaps S (S1, S2) at the shaft receiving holes 54 and the shaft support holes 16.

To adjust the direction of the resultant force K so as to satisfy the conditions, the (contact) positions of the components relevant to the pressures F1 to F4 relative to the photoconductor drum 21 may be adjusted. The pressure applied when the primary transfer roller 33 (including the intermediate transfer belt 31) contacts the photoconductor drum 21 is about 0.05 N as an example, and this is lower than the pressures F1 to F4 of the other components that contact the photoconductor drum 21. Therefore, this pressure is not used in calculation of the resultant force K.

### OTHER EMBODIMENTS

While the charging roller 221 of the charging device 22, the developing roller 241 of the developing device 24, and the drum cleaning device 25 (elastic blade 251) are integrally attached to the support plate 15 in the imaging device 2 of the exemplary embodiment, all or some of the components may be attached to (set in) the apparatus body 10, instead of being attached to the support plate 15, as long as the above-described conditions are satisfied. Further, the photoconductor drum 21 may be formed as a removable structure that is removably mounted in the apparatus body 10 of the image forming apparatus 1.

The photoconductor drum 21 may rotate together with the shaft 56. Since the shaft 56 serves as a rotation shaft in this case, the shaft support holes 16 of the support plate 15 rotatably support the shaft 56. The light emitting elements that form the light emitting portion 28 of the optical writing device 23 are not limited to the LEDs, and other light emitting elements may be used. The charging device 22 is not limited to a roll-shaped charging member like the illustrated charging roller 221 and may be formed by another type of charging member as long as the charging member is capable of contact charging. In addition, the developing device 24 is not limited to the developing roller 241 including the illustrated gap holding rollers 246, and may use a developing roller that rotates in direct contact with the photosensitive surface of the photoconductor drum 21 as long as the developing device is able to develop an electrostatic latent image.

The image forming apparatus 1 may directly transfer a toner image formed on the photoconductor drum 21 of the imaging device 2 onto the recording medium 9 without adopting the intermediate transfer method. In this case, the recording medium 9 may be directly transported between the photoconductor drum 21 and a transfer roller in the imaging device 2, or may be transported between the photoconductor drum 21 and the transfer roller while being held on a transport belt.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An imaging device comprising:
a cylindrical photoconductor having a photosensitive surface, the photoconductor rotating on a shaft;
a charging device that charges the photosensitive surface of the photoconductor by a charging member pressed into contact with the photosensitive surface;
an optical writing device that forms an electrostatic latent image by irradiating the charged photosensitive surface of the photoconductor with light emitted from a light emitting portion including a plurality of light emitting elements arranged in an axial direction of the photoconductor;
a developing device that develops the electrostatic latent image by a developing member in contact with the photosensitive surface of the photoconductor or a developing member opposing the photosensitive surface of the photoconductor with a gap holding member being disposed therebetween, the gap holding member being in contact with the photosensitive surface; and
a support member that rotatably supports the photoconductor while holding the shaft and supports the optical writing device at a distance from the photosensitive surface of the photoconductor, the distance corresponding to a focal length of the light emitted from the light emitting portion,
wherein the charging member of the charging device and the developing member of the developing device are respectively provided at portions of the photosensitive surface of the photoconductor closer to the optical writing device than a line extending orthogonally to an emitting direction of the light emitted from the light emitting portion of the optical writing device and passing through a center point of the shaft of the photoconductor, the portions being provided on opposite sides of the optical writing device, and
wherein each of an application direction of a pressure to be applied to the charging member and an application direction of a pressure to be applied to the developing member is set to intersect the emitting direction of the light emitted from the light emitting portion at an acute angle.

2. The imaging device according to claim 1, wherein the charging device and the developing device are attached to the support member.

3. An image forming apparatus comprising:
the imaging device according to claim 1;
a cleaning member that is pressed into contact with the photosensitive surface of the photoconductor in the imaging device; and
a transmitted gear provided on the photoconductor in the imaging device and meshed with a driving gear so that rotational force is transmitted to the transmitted gear,
wherein a pressure to be applied to the charging member, a pressure to be applied to the developing member, a pressure to be applied to the cleaning member, and a pressure produced by the rotational force to be transmitted to the transmitted gear are set so that a direction of a resultant force obtained by combining all of the pressures extends in the emitting direction of the light emitted from the light emitting portion of the optical writing device in the imaging device.

4. The image forming apparatus according to claim 3, wherein the charging device and the developing device in the imaging device and the cleaning member are attached to the support member in the imaging device.

5. An imaging device comprising:
a cylindrical photoconductor having a photosensitive surface, the photoconductor rotating on a shaft;
an optical writing device that forms a latent image by irradiating the charged photosensitive surface of the photoconductor with light emitted from a light emitting portion including a plurality of light emitting elements arranged in an axial direction of the photoconductor; and
a support member that rotatably supports the photoconductor while holding the shaft and supports the optical writing device at a distance from the photosensitive surface of the photoconductor, the distance corresponding to a focal length of the light emitted from the light emitting portion.

6. An imaging device comprising:
a cylindrical photoconductor having a photosensitive surface, the photoconductor rotating on a shaft;
a charging device that charges the photosensitive surface of the photoconductor by a charging member pressed into contact with the photosensitive surface;
an optical writing device that forms a latent image by irradiating the charged photosensitive surface of the photoconductor with light emitted from a light emitting portion including a plurality of light emitting elements arranged in an axial direction of the photoconductor;
a developing device that develops the latent image by a developing member in contact with the photosensitive surface of the photoconductor or a developing member opposing the photosensitive surface of the photoconductor with a gap holding member being disposed therebetween, the gap holding member being in contact with the photosensitive surface; and
a support member that rotatably supports the photoconductor while holding the shaft and supports the optical writing device at a distance from the photosensitive surface of the photoconductor, the distance corresponding to a focal length of the light emitted from the light emitting portion,
wherein each of an application direction of a pressure to be applied to the charging member and an application direction of a pressure to be applied to the developing member is set to intersect the emitting direction of the light emitted from the light emitting portion at an acute angle.
